(19) United States
(12) Patent Application Publication
(10) Pub. No.: US 2019/0354854 A1
(43) Pub. Date: Nov. 21, 2019

(54) Adjusting supervised learning algorithms with prior external knowledge to eliminate colinearity and causal confusion

(71) Applicant: Joseph L. Breeden, Santa Fe, NM (US)

(72) Inventor: Joseph L. Breeden, Santa Fe, NM (US)

(21) Appl. No.: 15/985,153

(22) Filed: May 21, 2018

(51) Int. Cl. G06N 3/08; G06N 3/04

(52) U.S. Cl. CPC G06N 3/08; G06N 3/04

(57) ABSTRACT

A type of machine learning called supervised learning is disclosed. In supervised learning, the training data contains observed values of a target variable and a set of candidate explanatory variables. Supervised learning has been used previously for predicting time series such as economic time series and separately for intrinsic behavior patterns such as credit scoring for offering consumer loans. However, when creating a single model of a target variable that combines both internal behavior and external drivers, the internal behavior and external drivers are often correlated to each other as well as to the target variable. In such a system, the external drivers are usually intended to capture the time series behavior and the internal behavioral variables capture the idiosyncratic effects, but when multicollinearity occurs across all these factors, the internal behavioral variables must also be predicted before a forecast can be created for the target variable. This complicated situation severely limits the interpretability and applicability of such systems.

The present invention solves the above described colinearity problem between internal and external factors by first creating a model of how the external factors drive behavior and adjusting the target variable for this known structure prior to creation of the machine learning model. This is similar to the way an offset term is used in generalized linear models (GLM). An external model is used to compute a set of coefficients that are fixed offset during the GLM estimation. The approach provides the same capability to neural network models.

This means that the current invention modifies the creation of the model so that the multicollinearity problem is solved such that no time series forecasting of the internal factors is required. All time series structure is concentrated into the initial external model.

### BACKGROUND OF THE INVENTION

### 1. Field of the Invention

The present invention relates to creating forecasting models for target variables that are impacted by both internal and external drivers, e.g. modeling consumer spending which is impacted by consumer behavior (internal) and economic factors (external). Since the internal and external factors can be correlated, properly separating effects is essential for accurate forecasting. Solving the problem is complicated when the external drivers have a short amount of data, such as economic factors. Learning algorithms have been very successful modeling large datasets, but in the dimension of economic data, the history is very short, so mixing a short history for economics with a large data set for internally observed performance factors is a classic example of this problem. This situation has previously been solved for regression-type models, for example, as illustrated in US Patent Application Publication No. 2014/0114880 A1, hereby incorporated by reference. The present invention provides a solution to this colinearity and casual confusion in the context of supervised machine learning.

### 2. Description of the Prior Art

The present invention involves a type of machine learning called supervised learning. In supervised learning, the training data contains observed values of a target variable and a set of candidate explanatory variables (Reed and Marks, 1999). Supervised learning has been used previously for predicting time series such as economic time series (Chakraborty, et. al., 1992; Kaastra, et. al, 1996) and separately for intrinsic behavior patterns such as credit scoring for offering consumer loans (West, 2000; Angelini, et. al., 2008).

However, when creating a single model of a target variable that combines both internal behavior and external drivers, the internal behavior and external drivers are often correlated to each other as well as to the target variable. In such a system, the external drivers are usually intended to capture the time series behavior and the internal behavioral variables capture the idiosyncratic effects, but when multicollinearity occurs across all these factors, the internal behavioral variables must also be predicted before a forecast can be created for the target variable. This complicated situation severely limits the interpretability and applicability of such systems.

This problem is well illustrated and quite acute in situations of stress testing retail loan portfolios. In such situations, for example, a supervised learning model of revolving balance on a credit card portfolio could be modeled as:

b(i, t)˜M[sⱼ(i, t), Eₖ(t)]

where b(i, t) is the balance for account i at time t. M is the supervised learning model built from input behavioral factors sⱼ(i, t) where j is one of n behavioral factors for account i and external macroeconomic factors Eₖ(t) where k is one of m total macroeconomic factors. When forecasting, no future information will be available for the sⱼ(i, t) account i, but stress test scenarios for the Eₖ(t) are usually provided by management or government examiners. During training, if the behavioral and economic factors are correlated, p(sⱼ,Eₖ)≠0, then we cannot create forecasts for the balance without first forecasting the behavioral factors as a function of the economic factors. This second step requires the creation of n additional forecast models, one for each of the behavioral factors, dramatically complicating the task.

As another example of the prior art, model M might be created using a neural network to predict the likelihood of default or pay-off. Models have been built to do exactly this, using “scoring” factors. Scoring factors are measures of recent account performance such as credit score, loan-to-value, delinquency, utilization, etc. Given large amounts of recent performance data, such models are often prove quite effective at predicting near-term defaults.

However, when macroeconomic factors are included in the scoring factors, they will be correlated to delinquency, utilization, etc. Given lots of data, learning algorithms can handle correlation, but no one has lots of loan performance history through economic cycles. Even 10 years of recent economic history is only around one economic cycle, which does not allow for a good separation of effects. Therefore, in contexts where both account performance data and economic data are used, the model produces unstable forecasts out-of-sample because of the unresolved correlations. The goal of the current invention is to resolve this short-coming in standard approaches.

### SUMMARY OF THE INVENTION

The present invention solves the above described colinearity problem between internal and external factors by first creating a model of how the external factors drive portfolio behavior. This can be achieved for normally distributed target variables by adjusting the target variable for this known structure prior to creation of the machine learning model. For binomially distributed target variables, a solution is provided for models that create probabilistic outputs, such as neural networks.

The solution is similar to the way an offset term is used in generalized linear models (GLM). An external model is used to pre-compute a set of parameters that are fixed during the GLM estimation. The approach provides the same capability for learning algorithms on normally distributed target variables and neural network models for binomially distributed variables. This method is not the same as assigning Bayesian priors because that still allows the learning algorithm to modify the priors and reintroduce confusion. Instead, a structural solution is disclosed that separates the short-history problem of capturing macroeconomic or lifecycle effects from the big data problem solved by learning algorithms to capture the nonlinear dependence of performance on account behavioral factors.

The present invention solves the problems associated with the prior art by modifying the creation of the initial model M so that the multicolinearity problem is solved such that no forecasting of the behavioral factors is required.

### DESCRIPTION OF THE DRAWING

These and other advantages of the present invention will be readily understood with reference to the following specification and attached drawing wherein:

FIG. 1 shows a high-level schematic of the invention. Input Dataset 1 (10) is processed by an External Drivers Algorithm (11) that creates a Model of External Drivers (12) of performance. This model is used by the Adjustment Algorithm (14) to adjust the Target Variable (13) in order to produce the Modified Target Variable (15). A Learning Algorithm (17) is then applied to the Input Dataset 2 (16) to create a Model of the Adjusted Target (18).

FIG. 2 shows a high-level schematic of creating forecasts with the invention. Input Dataset 3 (20) contains future input values for forecasting the external drivers and have the same structure as Input Dataset 1 (10). Input Dataset 3 (20) is processed by the Model of External Drivers (12) to produce the Forecasts of Adjustments (21). Input Dataset 4 (22) contains future input values for the learning algorithm forecasting and have the same structure as Input Dataset 2 (16). Input Dataset 4 (22) is processed by the Model of Adjusted Target (18) to produce the Forecasts of Adjusted Target Variable (23). The Recombination Algorithm (24) takes the Forecasts of Adjustments (21) and the Forecasts of Adjusted Target Variable (23) as inputs to produce the Forecasts of Target Variable (25).

FIG. 3 shows a specific schematic for the use of an Age-Period-Cohort (APC) algorithm to create the model of external drivers prior to forecasting with a neural network for the purpose of modeling loan performance data. Historic Loan Performance Data (30) is processed by the APC Algorithm (31) to produce outputs of Propensity by vintage (32), Environment by time (33), and Lifecycle by age (34). Target Variable: Revolving Balance (35) is modified by the APC Adjustment Algorithm (36) to remove the previously identified effects of Environment by time (33) and Lifecycle by age (34). Propensity by vintage (32) is discarded, since this structure will be replaced and refined with the Neural Network (39). The Adjusted Revolving Balance (37) is modeled by the Neural Network (39) with Loan Performance and Consumer Attributes Data (38) as explanatory inputs to produce the Model of Revolving Balance (40).

FIG. 4 shows a specific schematic for the use of the models from FIG. 3 and new input data to create forecasts of the target variable. Loan Performance Data 2 (45) contains future input values for forecasting the Environment Scenario by time (46) and has the same structure as Loan Performance Data (30). Lifecycle by age (34) is invariant with time, so it is carried forward from the previous analysis. The Environment Scenario by time (46) and Lifecycle by age (34) are combined to create the Forecasts of Adjustments (47). Separately, Loan Performance and Consumer Attributes Data 2 (48) has the same structure as Loan Performance and Consumer Attributes Data (38) and is input to the Model of Adjusted Revolving Balance (40) to generate the Forecasts of Adjusted Revolving Balance (49). Forecasts of Adjustments (47) and Forecasts of Adjusted Revolving Balance (49) are processed by the APC Recombination Algorithm (50) to produce the final Forecasts of Revolving Balance (51).

FIG. 5 shows the lifecycle function versus age of the loan obtained from the APC algorithm when applied to data on revolving balance for consumer credit cards.

FIG. 6 shows the environment function versus calendar date (time) obtained from the APC algorithm when applied to data on revolving balance for consumer credit cards.

FIG. 7 shows the propensity by vintage of the loan's behavior obtained from the APC algorithm when applied to data on revolving balance for consumer credit cards.

FIG. 8 shows the structure for the specific neural network learned to predict the adjusted 12-month average revolving utilization rate. The thickness and darkness of the lines indicate the magnitude of the coefficient to the final result.

FIG. 9 illustrates a solution for neural networks in which the given knowledge of Mₑₓₜ[Eₖ(t)] is one or multiple input nodes with a weight of 1.0 and the hidden layers connected directly to the output node in parallel to the rest of the inputs and usual neural network structure.

### DETAILED DESCRIPTION

The present invention relates to system and method for creating forecast models that solve the multicollinearity problem described in Prior Art for supervised learning algorithms. Specifically, multicollinearity between external drivers of performance like economics and internal drivers of performance like consumer attributes can be problematic because the internal drivers (consumer attributes) can also be driven by the external drivers (economics). The present invention resolves this problem by first modeling the direct impact of external drivers on performance, adjusting the target performance variable for this, and then using the learning algorithm to model just the adjusted part.

This problem has previously been solved in the specific context of creating loan-level stress test models of consumer loan delinquency using logistic regression. , as disclosed in Breeden, US Patent Application Publication No. US 2014/0114880,entitled: Computer Implemented Method for Estimating Age-Period-Cohort Models on Account Level Data, hereby incorporated by reference. As disclosed therein, an Age-Period-Cohort model was used to capture two specific external drivers, economic impacts on delinquency versus calendar date and lifecycle impacts versus the age of the loan. In the context of logistic regression, economic and lifecycle effects are used as a fixed offset in the estimation equation, meaning that their coefficients are each 1.0 in the final model. All other coefficients in the regression equation that are estimated on consumer behavioral attributes are estimated such that they provide adjustments relative to the fixed offsets but without changing those offsets. In this way, no problem arises from multicollinearity, because the offsets are taken as primary and the other coefficients capture the residuals.

Learning algorithms by their nature are very flexible, so they do not naturally support the sort of structural constraint described in the previous paragraph. Therefore, the current invention envisions a two-step process whereby any model can be used to capture the dominant external drivers. The outputs of that model are used to adjust the target variable and the learning algorithm models only the adjusted variable.

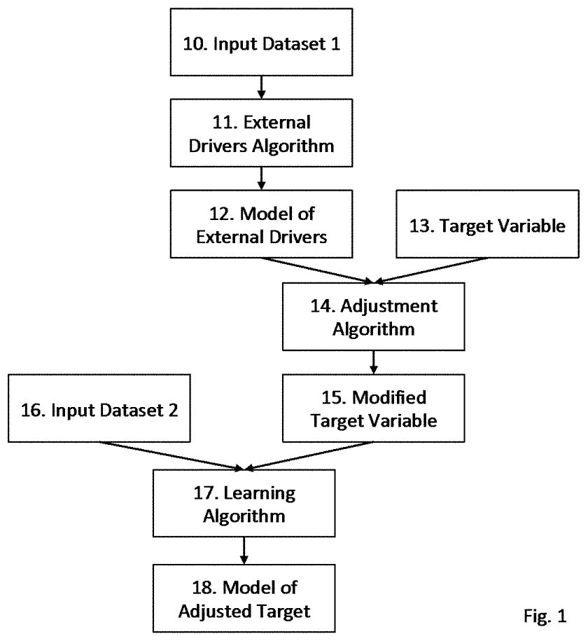

This can be expressed as follows. Instead of the previous learning algorithm definition of b(i, t)˜M[sⱼ(i, t), Eₖ(t)], where a single model is estimated on all input factors, and correlation between factors means that any factor sⱼ (i, t) that is correlated to external factors Eₖ(t) will also need a separate model Mₛⱼ[Eₖ(t)], the current invention separates the estimation into two models; b(i, t)˜Mₑₓₜ[Eₖ(t)]+Mᵢₙₜ[sⱼ(i, t)], as also illustrated in FIG. 1.

The above equation implies that the external model Mₑₓₜ and internal model Mᵢₙₜ are independent of one another. This independence is forced through the model estimation process. First, the external model is estimated as b(t)˜Mₑₓₜ[Eₖ(t)] where b(t) will vary only with the external drivers Eₖ(t), shown in Model of External Drivers (12) of FIG. 1.

Then the internal equation is estimated relative to the forecasts of the external model as b(i, t)˜\tilde{b}(t)+Mᵢₙₜ[sⱼ(i, t)] as shown in Learning Algorithm (17) in FIG. 1.

Normally Distributed Target Variable

If the target variable is normally or log-normally distributed, then this becomes simply b(i, t)−\tilde{b}(t)˜Mᵢₙₜ[sⱼ(i, t)], so that the learning algorithm uses input attributes sⱼ(i, t) to predict b(i, t)−\tilde{b}(t) and no models Mₛⱼ[Eₖ(t)] are needed.

The external and internal models can be of any type, but this invention is the first to demonstrate the importance of doing this for learning algorithms to solve the multicollinearity problem.

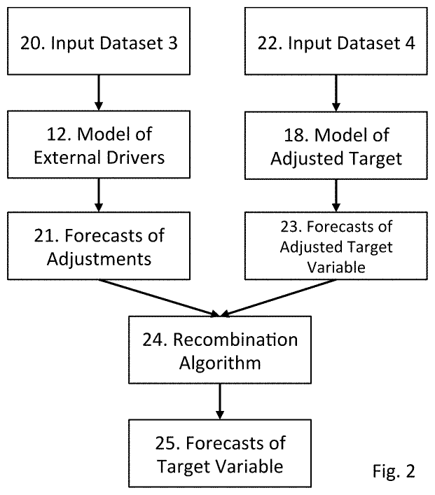

The forecasting process works as shown in FIG. 2. With revised input data, the Model of External Drivers (12) is used to compute the future adjustment to the target variable. Separately, the Model of Adjusted Target (18) is run to predict the performance from internal drivers. The two are combined to create the final forecasts of the target variable.

### Binomially Distributed Target Variable

For binary outputs such a predicting default or voluntary account closure (attrition, churn, or paid-in-full), the model of external impacts, Mₑₓₜ[Eₖ(t)], cannot be subtracted from 0 or 1 to create an adjusted target variable for modeling of internal effects, Mᵢₙₜ[sⱼ(i, t)]. Instead, the learning algorithm must incorporate the external model as a fixed component. This is not possible for discriminant analysis techniques, because they do not use an optimization function (such as likelihood function) that allows for the necessary adjustments. However, neural networks provide a good example of how to incorporate an input model Mₑₓₜ[Eₖ(t)] into the estimation process for the neural network that would seek to estimate Mᵢₙₜ[sⱼ(i, t)].

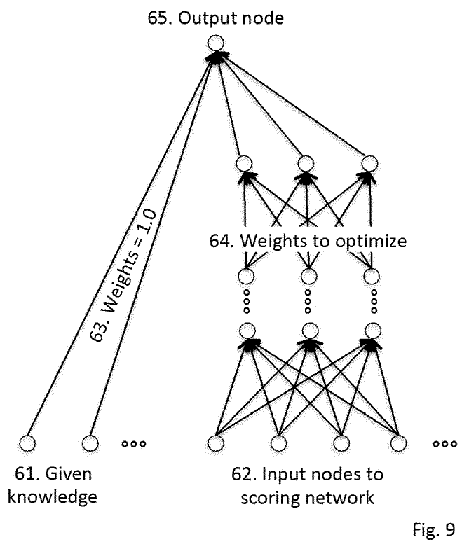

The solution for neural networks (FIG. 9) it so make the given knowledge of Mₑₓₜ[Eₖ(t)] as one or multiple input nodes (61) that have a weight of 1.0 (63) and skip the hidden layers (64). Those nodes would connect directly to the output node (65) in parallel to the rest of the inputs (62) and usual neural network structure (64). Any structure maybe be used for the neural network (62 and 64), but it is a minimum requirement that the given knowledge (61) have a direct connection to the output node (65) with no modification (63). Also important is that the activation function for the output node must match the optimization function used when creating the given knowledge. That will be demonstrated below.

The present invention may be implemented in terms of a neural network. Such neural networks are known in the art. Examples of such neural networks are disclosed in the following references, all hereby incorporated by reference:
Kanad Chakraborty, Kishan Mehrotra, Chilukuri K. Mohan, Sanjay Ranka, Forecasting the behavior of multivariate time series using neural networks, Neural Networks, Volume 5, Issue 6, November-December 1992, Pages 961-970
lebeling Kaastra, Milton Boyd, Designing a neural network for forecasting financial and economic time series, Neurocomputing, Volume 10, Issue 3, April 1996, Pages 215-236
David West, Neural network credit scoring models, Computers & Operations Research, Volume 27, Issues 11-12, September 2000, Pages 1131-1152
Eliana Angelini, Giacomo di Tollo, Andrea Roli, A neural network approach for credit risk evaluation, The Quarterly Review of Economics and Finance, Volume 48, Issue 4, November 2008, Pages 733-755
Russell D. Reed and Robert J. Marks II, Neural Smithing: Supervised Learning in Feedforward Artificial Neural Networks, MIT Press, 1999.

Other references include:
Breeden, J. L. (2016). Incorporating lifecycle and environment in loan-level forecasts and stress tests. European Journal of Operational Research, 255(2):649-658.
Holford, T. R. (1983). The estimation of age, period and cohort effects for vital rates. Biometrics, 39(2):311-324.

### SPECIFIC EXAMPLE #1: NORMALLY DISTRIBUTED TARGET VARIABLE

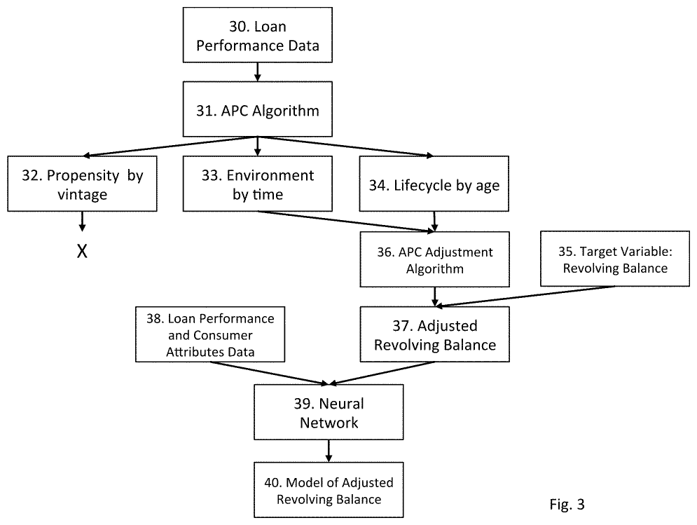

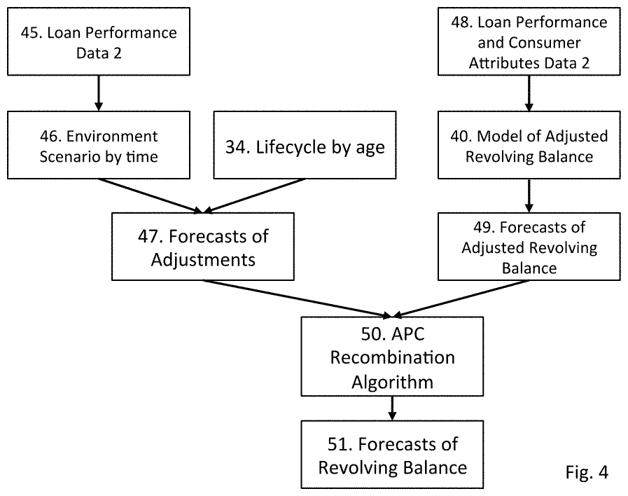

The above design can be illustrated by considering a specific case of predicting credit card revolving utilization as shown in FIG. 3 and FIG. 4. The target variable b(i, a, t) is the monthly balance for account i not paid off (revolving balance), divided by the credit limit, and averaged over the next year.

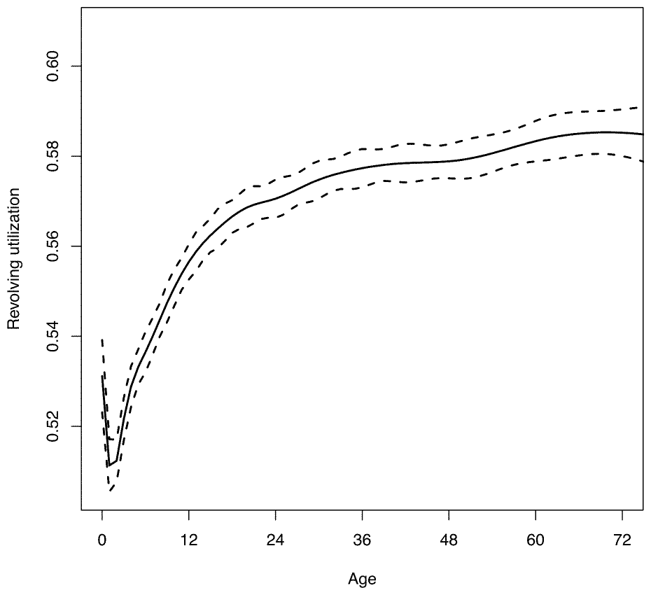

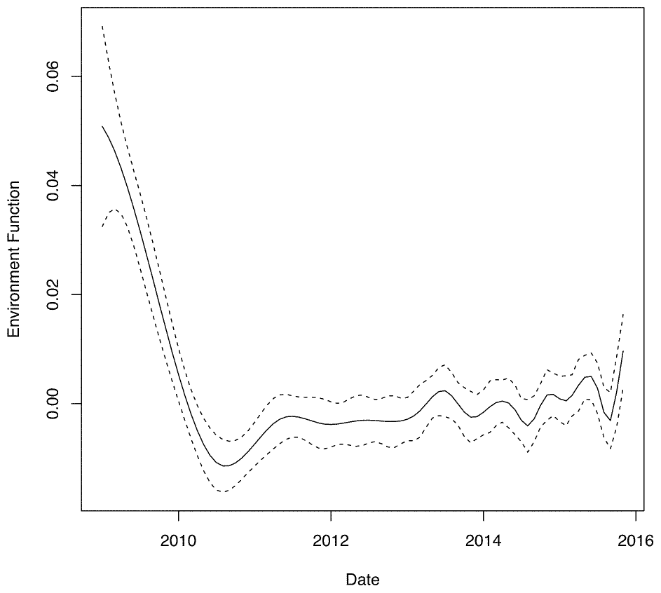

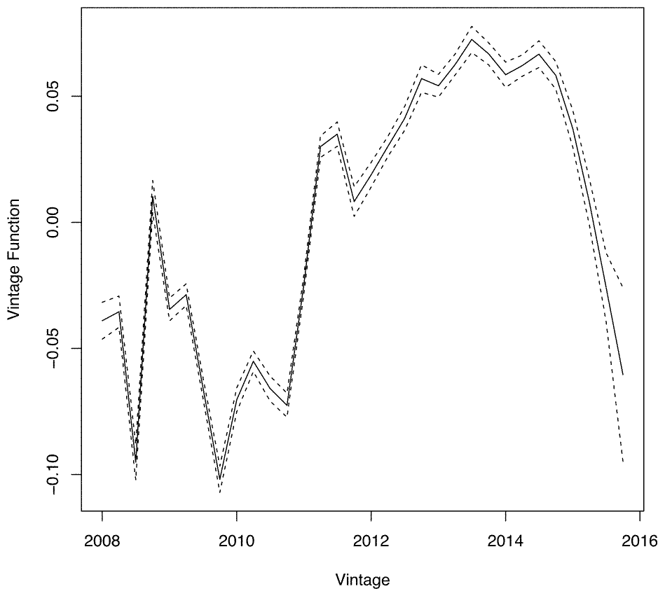

For the external model, APC Algorithm (31) of FIG. 3, an Age-Period-Cohort (APC) model (see Holford 1983) is estimated as b(a, v, t)˜F(a)+G(v)+H(t) where a is the age of the credit card, v in the origination date (vintage) of the card, and t is the calendar date. F (FIG. 5), G (FIG. 6), and H (FIG. 7) are nonlinear functions of age, vintage, and time, respectively. These functions were estimated using the Epi package in R with spline functions. There were 15, 21, and 19 spline nodes for the age, vintage, and time functions, respectively, which control the amount of nonlinearity in the estimated functions.

The vintage function is replaced with the learning algorithm using account behavior attributes. Therefore, the target variable is adjusted for the systematic effects of age and time that serve as significant external drivers to the performance. The APC Adjustment Algorithm (36) of FIG. 3 is simply, b·adj(a, v, t)=b(a, v, t)−F(a)−H(t).

The learning algorithm can then predict b·adj(a, v, t) using Loan Performance and Consumer Attributes Data (38), sⱼ(i, t).

There are twelve input variables:
CR.Limit: Current credit limit for the account
Apr.Orig: Annualized percentage rate at origination
Dep.Bal: Consumer's deposit balance with the lender
Delq.Days: Number of days delinquent
Score: Credit bureau score
Debt.Prot: Ownership of debt protection insurance
Prev.Util: Previous month's utilization rate as outstanding balance divided by credit limit
Prev.Utl.6 m: Average utilization rate of the previous six months
Prev.Bal: Previous month's outstanding balance
Prev.Pay: Previous month's payment rate as payment balance divided by outstanding balance
Prev.Pay.6 m: Average of the previous six months' payment rate
APR.chng: Change in the annualized percentage rate

Each input variable is transformed with a zscore function so that it would have a mean of zero and deviation of one.

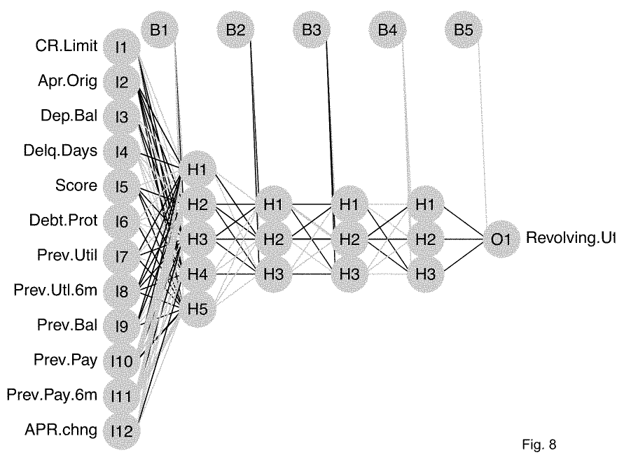

In this case, a Neural Network (39) estimation algorithm is used to create a Model of Adjusted Revolving Balance (40). Many different network structures were tested. The best structure for analyzing this data had four hidden layers with five nodes in the first hidden layer and three nodes each for the others. The final model had the structure and coefficients as shown in FIG. 8.

The neural network was trained on 2,000 data points in-sample. The resulting in-sample root-mean-square error (RMS error) was 0.00376. The forecasts were tested on 135,000 data points out-of-sample with a resulting RMS error of 0.000553. The RMS error is typically lower for the larger sample size because of the reduced importance of outliers.

This result is to be compared to a linear regression model created in a similar fashion to the neural network. Using the same inputs and adjusted revolving balance rate as the target variable, the linear model had an in-sample error of 0.00439 and out-of-sample error of 0.00177. In both cases the neural network had a lower error, indicating that non-linear structure is important.

The most significant result is that he adjusted revolving utilization does not have any trend with lifecycle or economic factors because of the adjustment prior to neural network modeling. Therefore, the neural network will be independent of economics and lifecycle, so that those factors may be added back in the last forecasting step as shown in FIG. 4. Therefore, the multicollinearity between the factors in the neural network and the economic model has been removed and each model is separately robust.

### SPECIFIC EXAMPLE #2: BINOMIALLY DISTRIBUTED TARGET VARIABLE

To demonstrate modeling binomially distributed target variables, publicly available data from Fannie Mae and Freddie Mac on mortgage loan performance was used to predict mortgage defaults. The given knowledge was created using an Age-Period-Cohort (APC) model to measure lifecycle versus age of the account, macroeconomic impacts versus calendar date, and credit risk by vintage. A neural network is used to replace the credit risk by vintage with a loan-level credit risk model using scoring factors of credit score, LTV, loan purpose, etc. The lifecycle and macroeconomic models from the APC model are taken as given knowledge, Mₑₓₜ[Eₖ(t)], that should be held fixed while the neural network is trained to estimate Mᵢₙₜ[sⱼ(i, t)].

The APC model is estimated using a logistic regression likelihood function, meaning that the lifecycle and environment functions will measure the change in log odds of default.

The output node can then use a logistic activation function with the given knowledge input nodes added to the hidden layer outputs of the neural network. The output node will be calibrated to a probability between the possible 0 and 1 default conditions.

In the tests on the mortgage data, this approach was effective at combining the given knowledge from the APC algorithm with the neural network. More generally, the given knowledge could have been generated from any model that captures long-term behavior, such as survival models and econometric models. The learning algorithm could be any structure that is compatible with a logistic activation function on the output node.

Although APC models and neural network models are both well known, they have never before been combinable in a single model. The structure shown in FIGS. 1-4 and 9 represent the key new insights of this patent.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

I claim:

1. A method of forecasting a binary target variable, comprising the steps of:
(a) creating a model to capture external drivers relevant to said binary target variable;
(b) creating a model to adjust said binary target variable based upon external factors defining an adjusted binary target variable; and
(c) creating a neural network to forecast the performance of said adjusted binary target variable.

2. A method of forecasting a binary target variable, comprising the steps of:
(a) creating an external time series model to capture the time dynamics of said binary target variable;
(b) creating a model to adjust said target variable based upon said time dynamics defining an adjusted binary target variable; and
(c) creating a neural network to forecast the performance of said adjusted binary target variable.

3. A method of forecasting a binary target variable, comprising the steps of:
(a) creating an external survival model to capture the age dynamics of said binary target variable;
(b) creating a model to adjust said binary target variable based upon said age dynamics defining an adjusted binary target variable; and
(c) creating a neural network to forecast the performance of said adjusted binary target variable.

4. A method of forecasting a binary target variable, comprising the steps of:
(a) creating an external age-period-cohort model to capture the age and time dynamics of said binary target variable;
(b) creating a model to adjust said binary target variable based upon said age and time dynamics defining an adjusted binary target variable; and
(c) creating a neural network to forecast the performance of said adjusted binary target variable.

5. A method of forecasting a continuous target variable, comprising the steps of:
(a) creating a model to capture external drivers relevant to said continuous target variable;
(b) creating a model to adjust said continuous target variable based upon external factors defining an adjusted continuous target variable; and
(c) using supervised learning to forecast the performance of said adjusted continuous target variable.

6. A method of forecasting a continuous target variable, comprising the steps of:
(a) creating an external time series model to capture the time dynamics of said continuous target variable;
(b) creating a model to adjust id continuous target variable based upon said time dynamics defining an adjusted continuous target variable; and
(c) using supervised learning to forecast the performance of said adjusted continuous target variable.

7. A method of forecasting a continuous target variable, comprising the steps of:
(a) creating an external survival model to capture the age dynamics of said continuous target variable;
(b) creating a model to adjust said continuous target variable based upon said age dynamics defining an adjusted continuous target variable; and
(c) using supervised learning to forecast the performance of said adjusted continuous target variable.

8. A method of forecasting a continuous target variable, comprising the steps of:
(a) creating an external age-period-cohort model to capture the age and time dynamics of said continuous target variable;
(b) creating a model to adjust said continuous target variable based upon said age and time dynamics defining an adjusted continuous target variable; and
(c) using supervised learning to forecast the performance of said adjusted continuous target variable.
